(19) United States
(12) Patent Application Publication
(10) Pub. No.: US 2020/0271095 A1
(43) Pub. Date: Aug. 27, 2020

(54) METHOD, APPARATUS AND SYSTEM FOR WIND CONVERTER MANAGEMENT

(71) Applicant: ABB Schweiz AG, Baden (CH)

(72) Inventors: Rongrong Yu, Beijing (CN); Niya Chen, Beijing (CN); Hailian Xie, Beijing (CN); Jiayang Ruan, Beijing (CN); Olli Alkkiomaki, Helsinki (FI)

(21) Appl. No.: 15/930,760

(22) Filed: May 13, 2020

Related U.S. Application Data
(63) Continuation of application No. PCT/CN2018/073309, filed on Jan. 18, 2018.

(51) Int. Cl. F03D 7/04; G05B 17/02; F03D 7/02

(52) U.S. Cl. CPC F03D 7/048; F03D 7/028; G05B 17/02

(57) ABSTRACT

A method for wind converter management, data of a first set of measurements may be collected from respective wind converters in a group of wind converters. Data distributions for the respective wind converters may be obtained based on the collected data. A condition of a first wind converter in the group of wind converters may be determined based on the obtained data distributions.

### TECHNICAL FIELD

Example embodiments of the present disclosure generally relate to wind turbine management, and more specifically, to methods, apparatuses and systems for managing a wind converter in a wind turbine in a wind farm.

### BACKGROUND

As wind energy is clean, pollution-free and renewable, wind power plays an increasingly important role in the worldwide exploration of new energy. A wind converter is an important device in the wind turbine, whose condition largely affects the output power of the wind turbine. Statistics show that the wind converter is the component with the highest failure rate, and most of the downtime in the wind turbine is caused by the abnormality of the wind converter. Accordingly, monitoring the condition of the wind converter is a significant task in wind turbine management. Typically, a wind farm is located in a remote area, and the wind turbines are distributed across a large geographic area. Thereby, it takes huge manpower, material resources and time cost in monitoring the condition of the wind converter.

There have been proposed solutions for monitoring the condition of the wind converter based on a knowledge model learned from collected measurements of the wind converters, where historical data reflecting a known condition (normal/abnormal condition) of the wind converter are needed to create the knowledge model. However, if it is desired to monitor the conditions of wind converters that are newly launched in a new wind farm or the historical data of the wind farm is incomplete or lost due to some reasons, the above proposed solutions cannot work. Accordingly, how to monitor the condition of the wind converter in a much effective and convenience manner becomes a focus.

### SUMMARY

Example embodiments of the present disclosure provide solutions for wind converter management.

In a first aspect, example embodiments of the present disclosure provide a method for wind converter management. The method comprises: collecting data of a first set of measurements from respective wind converters in a group of wind converters; obtaining data distributions for the respective wind converters based on the collected data; and determining a condition of a first wind converter in the group of wind converters based on the obtained data distributions. For the traditional solution, both the historical data and the condition associated with the historical data should be known for determining the current of the wind converter. However, with these embodiments, the condition of the first wind converter may be determined based on a comparison among the wind converter and other wind converter without the historical data. Therefore, the condition may be monitored in a much convenient and effective manner.

In some embodiments, the determining a condition of the first wind converter comprises: in response to a determination that the data distribution for the first wind converter deviates from data distributions for other wind converters in the group of wind converters, identifying the first wind converter as abnormal. As data distributions for other wind converters may reflect the operations of most of the wind converter, if there is a deviation, it may indicate a potential abnormal condition in the first wind converter. Accordingly, the conditions of the wind converter may be monitored in a simple and effective way based on the data distributions of the wind converters.

In some embodiments, the method further comprises: in response to the first wind converter being identified as abnormal, determining, from the first set of measurements, a candidate measurement that results in a high contribution of the deviation; and determining a cause of an exception in the first wind converter based on the candidate measurement. With these embodiments, once an abnormal condition is detected in the first wind converter, a cause may be tracked and then an early maintenance may be implemented so as to protect the abnormal wind converter from further damage.

In some embodiments, the method further comprises: in response to the first wind converter being identified as abnormal, removing the first wind converter from the group of wind converters to form an updated group of wind converters; and determining a condition of a second wind converter in the updated group of wind converters based on the obtained data distributions. Sometimes, a significant deviation related to the first wind converter may hide a minor deviation related to another wind converter. With these embodiments, after wind converter being seriously abnormal is removed from the group of to-be-monitored wind converters, the deviation of another potential wind converter may be exposed.

In some embodiments, the determining data distributions comprises: for at least one wind converter in the group of wind converters, determining the data distribution by a Gaussian Mixture Model (GMM). GMM is a successful algorithm in the field of clustering, and it may increase the accuracy in determining the data distribution.

In some embodiments, the determining data distributions comprises: for at least one wind converter in the group of wind converters, obtaining reduced-dimension data based on the data of the first set of measurements by a dimension-reducing process; and determining the data distribution based on a data distribution of the reduced-dimension data. Sometimes, a great number of measurements of the wind converters may be collected, which results in a high dimension of the collect and in turn increases the complexity of the further processing. With these embodiments, the dimension data may be reduced to a lower one, on one hand the computing cost may be lowered to an acceptable level, on the other hand, the data that significantly affects the data distribution may be highlighted.

In some embodiments, the method further comprises: determining the first set of measurements by classifying a plurality of measurements of the wind converters into sets according to any of: locations at which the plurality of measurements are produced in the wind converters; and/or a prior knowledge about an association relationship among the plurality of measurements. The measurements may be of a great number and if all these measurements are considered in determining data distribution, chaos may be caused in the data distribution. In these embodiments, by dividing the measurements into several sets, the data distribution associated with each of the set of measurements may clearly reflect one aspect of the condition of the wind converters.

In some embodiments, the method further comprises: collecting second data of a second set of measurements from respective wind converts in a group of wind converters; obtaining second data distributions for the respective wind converters based on the second data; and determining the condition of the first wind converter based on the second data distributions. In these embodiments, the first and second sets may include measurements collected from two components in the first wind converter. At this point, the conditions of the two components may be determined respectively.

In some embodiments, the method further comprises: in response to data distributions for the group of wind converters being in consistent with each other, identifying the group of wind converters as normal. With these embodiments, if the data distributions of all the wind converters are similar, it may indicate that all the wind converters may be in good condition (although all the wind converters might be abnormal, the possibility is significantly low). However, according to the traditional solution, each of the wind converters should be monitored one by one.

In some embodiments, the method further comprises: in response to the wind converter being identified as abnormal, adjusting an output power of the wind converter; and/or adjusting an output power dispatch among the group of wind converters. With these embodiments, once an abnormal condition is detected in the wind converter, an early maintenance at a level of the wind converter (such as lowering down the output power) may be implemented so as to protect the abnormal wind converter from further damage. Further, once an abnormal condition is detected in the wind converter, an early maintenance at a level of the wind farm (such as rescheduling the output powers among the wind converters in the wind farm) may be implemented so as to provide a stable output power from the wind farm.

In a second aspect, example embodiments of the present disclosure provide an apparatus for wind converter management. The apparatus comprises: a collecting unit configured to collect data of a first set of measurements from respective wind converters in a group of wind converters; an obtaining unit configured to obtain data distributions for the respective wind converters based on the collected data; and a determining unit configured to determine a condition of a first wind converter in the group of wind converters based on the obtained data distributions.

In some embodiments, the determining unit comprises: an identifying unit configured to, in response to a determination that the data distribution for the first wind converter deviates from data distributions for other wind converters in the group of wind converters, identify the first wind converter as abnormal.

In some embodiments, the apparatus further comprises: a measurement determining unit configured to, in response to the first wind converter being identified as abnormal, determine, from the first set of measurements, a candidate measurement that results in a high contribution of the deviation; and a cause determining unit configured to determine a cause of an exception in the first wind converter based on the candidate measurement.

In some embodiments, the apparatus further comprises: a removing unit configured to, in response to the first wind converter being identified as abnormal, remove the first wind converter from the group of wind converters to form an updated group of wind converters; and the condition determining unit is further configured to determine a condition of a second wind converter in the updated group of wind converters based on the obtained data distributions.

In some embodiments, the determining unit comprises: a distribution determining unit configured to for at least one wind converter in the group of wind converters, determine the data distribution by a Gaussian Mixture Model.

In some embodiments, the determining unit comprises a distribution determining unit configured to: for at least one wind converter in the group of wind converters, obtain reduced-dimension data based on the data of the first set of measurements by a dimension-reducing process; and determine the data distribution based on a data distribution of the reduced-dimension data.

In some embodiments, the apparatus further comprises: a classifying unit configured to classify a plurality of measurements of the wind converters into sets according to any of: locations at which the plurality of measurements are produced in the wind converters; and/or a prior knowledge about an association relationship among the plurality of measurements.

In some embodiments, the collecting unit is further configured to collect second data of a second set of measurements from respective wind converts in a group of wind converters; the obtaining unit is further configured to obtain second data distributions for the respective wind converters based on the collected second data; and the determining unit is further configured to determine the condition of the first wind converter based on the second data distributions.

In some embodiments, the determining unit comprises: an identifying unit configured to in response to data distributions for the group of wind converters being in consistent with each other, identify the group of wind converters as normal.

In some embodiments, the apparatus further comprises: an adjusting unit configured to, in response to the first wind converter being identified as abnormal, adjust an output power of the first wind converter; and/or adjust an output power dispatch among the group of wind converters.

In a third aspect, example embodiments of the present disclosure provide a system for wind converter management. The system comprises: a computer processor coupled to a computer-readable memory unit, the memory unit comprising instructions that when executed by the computer processor implements the method for wind converter management.

In a fourth aspect, example embodiments of the present disclosure provide a computer readable medium having instructions stored thereon, the instructions, when executed on at least one processor, cause the at least one processor to perform the method for wind converter management.

In a fifth aspect, example embodiments of the present disclosure provide an Internet of Things (IoT) system. The system comprises: a group of wind converter; and an apparatus for wind converter management.

### DESCRIPTION OF DRAWINGS

Drawings described herein are provided to further explain the present disclosure and constitute a part of the present disclosure. The example embodiments of the disclosure and the explanation thereof are used to explain the present disclosure, rather than to limit the present disclosure improperly.

FIG. 1 illustrates a schematic diagram for wind converter management in accordance with embodiments of the present disclosure;

FIG. 2 illustrates a schematic flowchart of a method for wind converter management in accordance with embodiments of the present disclosure;

FIG. 3 illustrates a schematic diagram for identifying an abnormal wind converter based on data distributions for a group of wind converters in accordance with embodiments of the present disclosure;

FIG. 4 illustrates a schematic flowchart of a method for wind converter management in accordance with embodiments of the present disclosure;

FIG. 5 illustrates a schematic diagram for identifying an abnormal wind converter based on a Gaussian Mixture Model (GMM) algorithm in accordance with embodiments of the present disclosure;

FIG. 6 illustrates a schematic diagram for identifying an abnormal wind converter based on a dimension-reducing algorithm in accordance with embodiments of the present disclosure;

FIG. 7 illustrates a schematic diagram for determining a cause of an exception in an abnormal wind converter in accordance with embodiments of the present disclosure;

FIG. 8 illustrates a schematic flowchart of a method for managing a group of wind converters in accordance with embodiments of the present disclosure;

FIG. 9 illustrates a schematic diagram of an apparatus for wind converter management in accordance with embodiments of the present disclosure; and

FIG. 10 illustrates a schematic diagram of a system for wind converter management in accordance with embodiments of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

For a device that no historical record is maintained, there is proposed a solution to determine the condition of the device by comparing corresponding data collected from two devices to determine which device is a normal one. In this solution, discrete data of each measurement collected from the two devices is compared in individual rounds. As the discrete data cannot reflect whole pictures of the devices, the accuracy degree of the proposed solution is not satisfactory.

In order to at least partially solve the above and other potential problems, a new method for wind converter management is disclosed according to embodiments of the present disclosure. For the sake of description, embodiments of the present disclosure will be described in an environment of a wind farm. The wind farm may comprise a plurality of wind turbines. The wind turbine may comprise various devices and among them the wind converter for converting the wind power to the electrical power is a particular important one. Accordingly, the condition of the wind converter is a key factor for the health of the wind turbine.

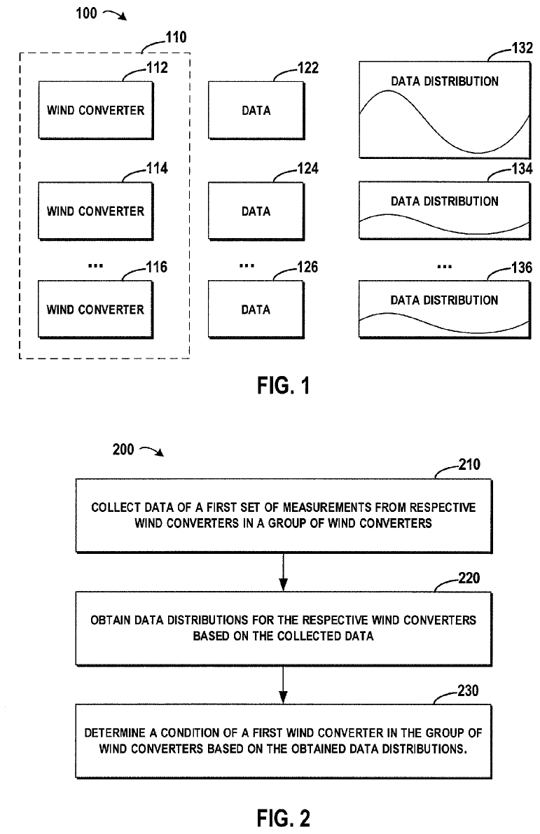

Reference will be made to FIG. 1 to provide a general description of one embodiment of the present disclosure. FIG. 1 illustrates a schematic diagram 100 for wind converter management in accordance with embodiments of the present disclosure. As illustrated in FIG. 1, there may be a group 110 of wind converters 112, 114, . . . , and 116 in the wind farm. During the daily operation of the wind farm, data 122, 124, . . . , and 126 of a first set of measurements may be collected from the wind converters 112, 114, . . . , and 116, respectively. Further, based on each of the collected data 122, 124, . . . , and 126, the data distribution may be obtained for each of the wind converters 112, 114, . . . , and 116.

With these embodiments, the condition of the first wind converter may be determined based on a comparison among the wind converter and other wind converter without the historical data. Therefore, the condition may be monitored in a much convenient and effective manner.

It is to be understood that the patterns of the data distributions in FIG. 1 are just for illustration. In the specific environment, there may be several or tens of measurements and thus the data distribution may show a different pattern. Usually, it is believed that the data distributions of most of the wind converters may show normal behaviors of the wind converters. Therefore, the condition of the wind converter 112 may be determined based on the data distributions 132, 134, . . . , and 136.

Details of the embodiments of the present disclosure will be provided with reference to FIG. 2, which illustrates a schematic flowchart of a method 200 for wind converter management in accordance with embodiments of the present disclosure. At 210, data of a first set of measurements may be collected from respective wind converts in a group of wind converters. Here, the first set of measurements may comprise various measurements such as the temperatures of various components in the wind converter and so on. The measurements may vary according to types (including brands and models) of the wind converter. Table 1 illustrates a plurality of measurements associated with a specific type that may be included in the first set of measurements.

TABLE 1
Example Measurements for Wind Converter

| Measurement | |
|---|---|
| Name | Description |
| AIPt100 | Measured value of the Pt100 temperature |
| CabinTemp | Measured cabinet temperature |
| ISUPPTemp | The maximum of the measured IGBT temperature of |
| | the grid-side converter |
| ISUCurrent | Grid-side current of the grid-side converter |
| ISUPower | Grid-side power of the grid-side converter |
| ISUReactP | Grid-side reactive power of the grid-side converter |
| PPTemp | The maximum of the measured IGBT temperature of |
| | the rotor-side converter |
| RotorIU | The measured rotor current of phase U |
| RotorIY | The measured rotor current of phase U and W |
| | transferred into xy-coordinates |
| RotorPower | The rotor (rotor-side converter output) power |
| SwitchingFreq | The switching frequency produced by the DTC |
| | modulation* |
| PhaseUTempDif | Difference between the maximum phase U |
| | temperature and the average from the |
| | rest of the power modules |
| PhaseVTempDif | Difference between the maximum phase V |
| | temperature and the average from the |
| | rest of the power modules |
| PhaseWTempDif | Difference between the maximum phase W |
| | temperature and the average from the |
| | rest of the power modules |
| ISUMainVolt | The grid voltage of the grid-side converter. |
| MinPHtoPHVolt | The lowest measured ph-to-ph rms voltage in volts |
| RotorVoltage | The calculated effective (rms) rotor voltage |
| SeqVolt | The grid voltage negative sequence in volts. |
| EfCurrrentAct | The actual value of measured current unbalance |
| DCVoltage | The measured DC link voltage |

In this embodiment of the present disclosure, the first set measurements may comprise at least one portion of the measurements as illustrated in Table 1. It is to be understood that Table 1 just shows example measurements for one wind converter. For another wind converter with another type, the measurements may comprise more, less or different measurements.

At 220, data distributions for the respective wind converters may be obtained based on the collected data. Here, various methods may be utilized for determining the data distributions. In one example, a Gaussian Mixture Model (GMM) method may be used for determining the data distributions. In another example, the dimension of the collected data may be reduced to a lower one. For example, the dimension may be reduced to two from the number of the measurements in the first set. Details will be presented in the following paragraphs.

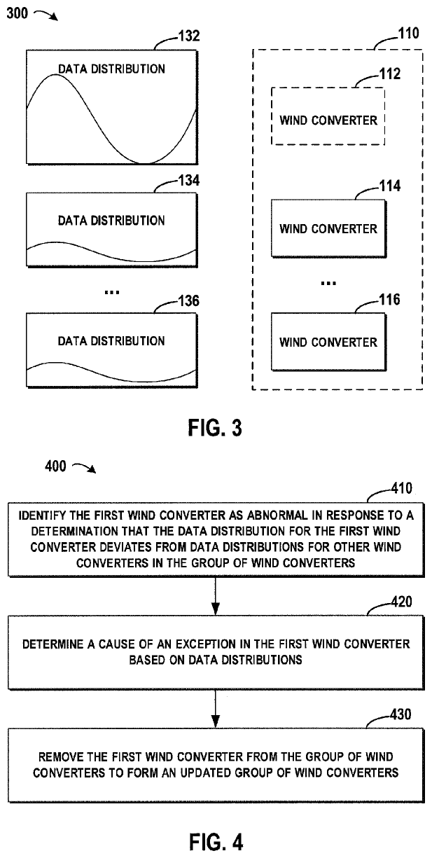

At 230, a condition of a first wind converter in the group of wind converters may be determined based on the obtained data distributions. Reference will be made to FIG. 3, which illustrates a schematic diagram 300 for identifying an abnormal wind converter based on data distributions for a group of wind converters in accordance with embodiments of the present disclosure.

FIG. 3 illustrates the data distributions 132, 134, . . . , and 136, where the data distribution 132 covers a relative large range along the vertical direction, while the data distributions 134, . . . , and 136 cover only a relative small range along the vertical direction. As illustration in FIG. 3, the data distributions 134, . . . , and 136 share a similar pattern with small changes, while the data distribution 132 shows a significant change. Therefore, the data distribution 132 of the wind converter 112 is different from those of the others. Due to the data distribution that is shared by most of the wind converters usually represents a normal behavior, based on the data distributions 132, 134, . . . , and 136, the condition of the wind converter 112 may be determined as different from those of the other wind converters 114, . . . , 116. In other words, the wind converter 112 may be identified as an abnormal one.

Usually, a group of wind converters located nearby will operate in a similar manner and thus the data distributions related to various measurements of the respective wind converters will show a similar distribution. If the data distribution of the wind converter is different from those of the others, it may be reasonable to believe that the wind converter is possibly in an abnormal condition. With the above embodiments of the present disclosure, the condition of the wind converter may be determined in an efficient and convenient manner by determining whether the wind converter behaves in a different mode among all the neighbors.

In some embodiments of the present disclosure, the condition of the first wind converter may be determined based on whether the data distribution of the first wind converter is similar with those of the other wind converters in the group. Specifically, if it is determined that the data distribution for the first wind converter deviates from data distributions for other wind converters in the group, the first wind converter may be identified as abnormal. Referring to the example in FIG. 3, as the data distribution 132 for the wind converter 112 greatly deviates from the data distributions 134, . . . , and 136 for the other wind converters 114, . . . , and 116, the wind converter 112 may be identified as an abnormal one. In these embodiments, the conditions of the wind converter may be monitored in a simple and effective way based on a comparison of the data distributions of the wind converters.

In some embodiments of the present disclosure, if data distributions for all the wind converters in the group are in consistent with each other, then the group of wind converters may be identified as normal. Usually, the wind converter runs normally for most of the time and the possibility that an exception occurs in the wind converter is very low. Based on this, the possibility that exceptions occur in all the wind converters is significant low. Therefore, if the data distributions for all the wind converters are in consistent with each other, it may indicate that all the wind converters work normally. With these embodiments, if the data distributions of all the wind converters are similar, it may indicate that all the wind converters may be in good condition. However, according to the traditional solution, each of the wind converters should be monitored one by one.

Based on the embodiments of the present disclosure, conditions of wind converters in the wind farm may be monitored. Afterwards, the monitored conditions may be grounds for further operations for managing the wind converter as well as the wind farm. For example, based on the monitored conditions, the maintenance activity may be scheduled in advance in a more efficient manner, potential loss caused by device breakdown may be reduced, and the lifetime of whole wind farm may be balanced proactively.

Reference will be made to FIG. 4 for describing other procedures that may be performed in the wind converter management. FIG. 4 illustrates a schematic flowchart of a method 400 for managing an abnormal wind converter in a group of wind converters in accordance with embodiments of the present disclosure. At 410, the first wind converter may be identified as abnormal if it is determined that the data distribution for the first wind converter deviates from those for the other wind converters.

At 420, a cause of an exception in the first wind converter may be determined based on the data distributions. For example, supposing the first set of measurements comprises 5 measurements, if the data of 4 measurements collected from the first wind converters is inconsistent with the that of the other wind converters in the group and only the data of 1 measurement from the first wind converters deviates from that of the other ones, then it may indicate that the deviation of this measurement may be the cause of the exception.

At 430, the first wind converter may be removed from the group of wind converters to form an updated group of wind converters. Supposing initially there are 10 wind converters (with IDs of “WC1,” “WC2,” . . . , and “WC10”) in the group, once one wind converter (for example, “WC1”) is identified as abnormal, then “WC1” may be removed from the group to form an updated group including “WC2,” . . . , and “WC10.” In some embodiments of the present disclosure, the methods of the embodiments may be performed in a regression manner for the updated group of wind converters until all the wind converts in the updated group are identified as normal ones.

In some embodiments of the present disclosure, after the first wind converter is removed, a condition of a second wind converter included in the updated group of wind converters may be determined based on the obtained data distributions. As there may be tens of or even more wind converters in the group, sometimes, a significant deviation related to one wind converter may hide a minor deviation related to another wind converter. By repeating the above method, the wind converter with a minor deviation may be found.

In these embodiments, the above method may be repeated in several rounds to identify all the abnormal wind converters gradually. Continuing the above example, if the data distribution for “WC1” shows the most significant deviation, “WC1” may be removed from the group in the first round. In the second round, if the date distribution for “WC3” which is hidden by the data distribution for “WC1” becomes the most significant one after “WC1” is removed. At this point, “WC3” may be identified as an abnormal one and removed from the updated group. With the above embodiments, all of the abnormal wind converters may be found in a descending order of the abnormal degree.

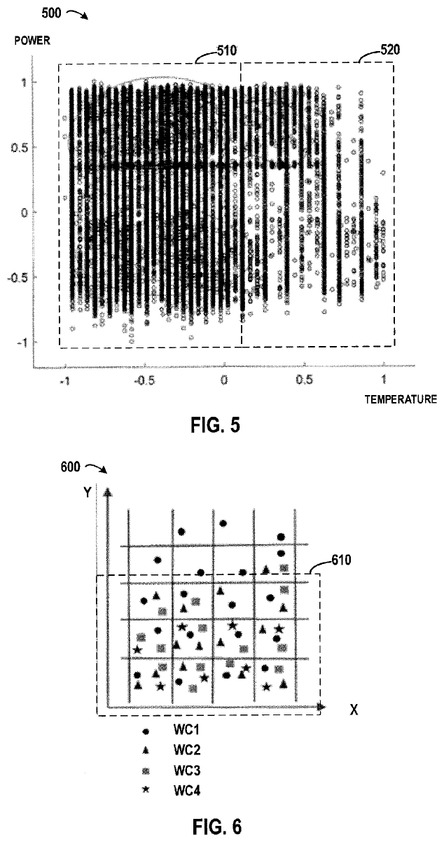

In some embodiments of the present disclosure, for at least one wind converter in the group of wind converters, the data distribution may be determined by a GMM method. In statistics, a GMM is a probabilistic model for representing a data distribution of the collected data. Details will be described with reference to FIG. 5, which illustrates a schematic diagram 500 for identifying an abnormal wind converter based on a GMM algorithm in accordance with embodiments of the present disclosure.

For the purpose of illustration, supposing the first set includes only two measurements: “AIPt100” and “ISUPower” in Table 1. FIG. 5 illustrates the data distributions in a 2D coordinate, where the horizontal axis indicates the temperature (measurement “AIPt100”), and the vertical axis indicates the power (measurement “ISUPower”). Here, the amplitudes of the two axes are normalized to the range of [−1, 1] for illustration.

It is to be understood that FIG. 5 is just a simplified example, and the first set may include more measurements. For example, if the first set includes three measurements, the corresponding data distribution will be illustrated in a 3D coordinate. For monitoring the condition of a real wind converter, usually there may be more measurements in the first set, and those skilled in the art may determine the data distributions with a higher dimension.

As illustrated in FIG. 5, black dots within a block 510 may indicate data distributions of data collected from “WC2” to “WC10,” and gray dots within a block 520 may indicate a data distribution of data collected from “WC1.” As data related to most of the wind converters (9 out of 10) distributes within the block 510 and data related to only one wind converter (1 out of 10) distributes within the block 520, the wind converter “WC1” may be identified as abnormal.

In some embodiments of the present disclosure, for at least one wind converter in the group of wind converters, the dimension of the collected data may be reduced to a lower one. Specifically, reduced-dimension data may be determined based on the data of the first set of measurements by a dimension-reducing process, and then the data distribution may be determined based on a data distribution of the reduced-dimension data. With these embodiments, the further computing may be implemented in the reduced-dimension and then the computing may be reduced. Further, as irrelevant data may be filtered out by the dimension-reducing process, the condition of the wind converter may be determined in a more accurate manner, and the computing cost may be lowered to an acceptable level.

FIG. 6 illustrates a schematic diagram 600 for identifying an abnormal wind converter based on a dimension-reducing algorithm in accordance with embodiments of the present disclosure. In some embodiments, the dimension of the data may be reduced to a lower number such as two. Here the dimension may be reduced to 2 as illustrated by the X and Y axes in FIG. 6. It is to be understood that the X and Y axes do not have physical meanings after the dimension-reducing. Various methods may be adopted in the dimension-reducing process, for example, Principal Component Analysis (PCA) may be a candidate process. Details of the PCA process are omitted hereinafter and those skilled in the art may refer to the prior art documents.

Referring to the legends, different shapes refer to different wind converters, where the dots indicate data associated with “WC1,” the triangles indicate data associated with “WC2,” the squares indicate data associated with “WC3,” and the stars indicate data associated with “WC4.” In order to clearly illustrate the data distribution after the dimension-reducing process, grids are added into the coordinate.

FIG. 6 illustrates data distributions of the four wind converters “WC1” to “WC4,” where the data distributions of 3 wind converters (“WC2” to “WC4”) are basically within the block 610 while only the data distribution of “WC1” is outside the block 610. At this point, as the data distribution of “WC1” deviates from the other wind converters, “WC1” may be identified as an abnormal one. In FIG. 6, the illustrated example may be referred to as a “grid-outlier” method, where the grids help to define an outlier of the normal data distributions shared by most of the wind converters. In the “grid-outlier” method, the wind converter locates beyond the outlier may be identified as the abnormal wind converter. Here, the dimension reduction is an optional step. If the original dimension is high and brings considerable difficulty on outlier detection, the dimension-reducing process is recommended. Alternatively, the dimension-reducing process may be omitted.

In some embodiments of the present disclosure, if the first wind converter is identified as an abnormal one, a cause of an exception in the first wind converter may be traced. Specifically, a candidate measurement that results in a high contribution of the deviation may be determined from the first set of measurements, and then a cause of an exception in the first wind converter may be determined based on the candidate measurement. With these embodiments, a cause may be traced into the wind converter, such that trouble-shooting engineers may check and fix the exception in a more efficient way.

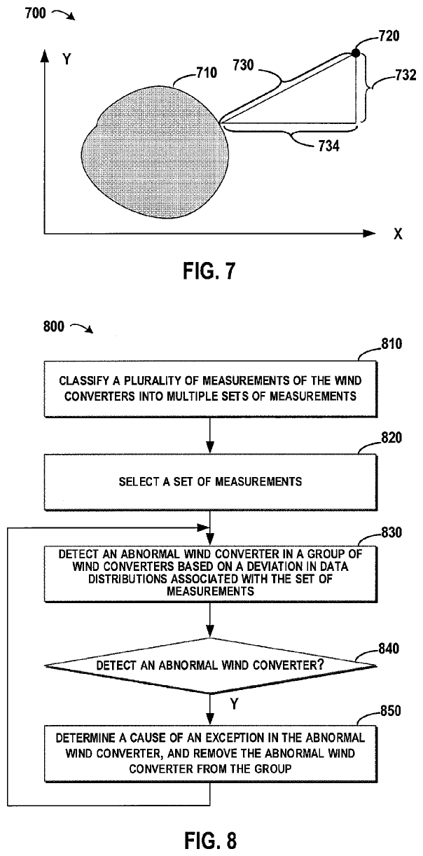

FIG. 7 illustrates a schematic diagram 700 for determining a cause of an exception in an abnormal wind converter in accordance with embodiments of the present disclosure. In the example of FIG. 7, data distributions after the dimension-reducing process are illustrated, where an area 710 indicates a normal area. Here, the area 710 means that if the data distribution of one wind converter is within the area 710, then the wind converter may be identified as a normal one. According to FIG. 7, the wind converter (for example “WC1” indicated by a dot 720) whose data distribution is outside the area 710 may be identified as an abnormal one.

As illustrated in FIG. 7, a distance 730 between the area 710 and the dot 720 indicates a deviation of “WC1” from the normal wind converters. It is to be understood that the distance 730 depends on a combination of the distances 734 and 732 along the X and Y axes respectively. Further, the distances 734 and 732 along the X and Y axes depend on a combination of distances in the original dimensions before the dimension-reducing process. At this point, the contribution of each of the original dimensions before the dimension-reducing process to the distance 730 may be determined to find which original dimension provides the highest contribution to the distance 730.

Supposing the first set includes 3 measurements (ISUCurrent, ISUPower, and ISUPPTemp) and thus the original dimension is 3. During the dimension-reducing process, 2 measurements (ISUCurrent and ISUPower) are mapped to the Y axis and 1 measurement (ISUPPTemp) is mapped to the X axis. Referring to the distances 734 and 732, the distance 734 along the X axis is twice as great as the distance 732 along the Y axis. Based on the above, the measurement ISUPPTemp may be determined to provide the highest contribution to the deviation. Therefore, the device associated with the measurement ISUPPTemp may be determined as the cause of the exception in “WC1.” Further, the component where the measurement ISUPPTemp is produced may be determined as a candidate component that causes the exception of the wind converter.

The above measurements have described the process for monitoring one of a group of wind converters based on a first set of measurements. In some embodiments of the present disclosure, there may be tens of or even more measurements. Usually, if data related to a large number of measurements are collected, the data distributions may show a complex pattern and the performance for determining an abnormal wind converter may drop. Moreover, if all the measurements arc included in one set, some measurements associated with strong deviation may influence other weakly deviated ones, such that some abnormal wind converter may not be identified. Accordingly, those measurements may be classified into several sets, and then the above described method may be implemented for each of these sets of measurements. With these embodiments, the abnormal wind converter may be identified in a more accurate manner.

In some embodiments of the present disclosure, the sets of measurements may be determined according to locations at which the plurality of measurements are produced in the wind converters. Usually, the wind converter may include multiple components connected to each other. For example, in one specific model of wind converter, there are two cabinets (an ISU cabinet and an INU cabinet) in the wind converter. At this point, the measurements that are produced from the ISU cabinet may be classified into the first set and the measurements that are produced from the INU cabinet may be classified into the second set. Tables 2 and 3 illustrate example set of measurements of the wind converter.

TABLE 2
Example Set of Measurements

| Measurement | |
|---|---|
| Name | Description |
| AIPt100 | Measured value of the Pt100 temperature |
| CabinTemp | Measured cabinet temperature |
| ISUPPTemp | The maximum of the measured IGBT temperature of |
| | the grid-side converter |
| ISUCurrent | Grid-side current of the grid-side converter |
| ISUPower | Grid-side power of the grid-side converter |
| ISUReactP | Grid-side reactive power of the grid-side converter |

TABLE 3
Example Set of Measurements

| Measurement | |
|---|---|
| Name | Description |
| PPTemp | The maximum of the measured IGBT temperature of |
| | the rotor-side converter |
| RotorIU | The measured rotor current of phase U |
| RotorIY | The measured rotor current of phase D and W |
| | transferred into xy-coordinates |
| RotorPower | The rotor (rotor-side converter output) power |
| SwitchingFreq | The switching frequency produced by the DTC |
| | modulation* |

In some embodiments of the present disclosure, the sets of measurements may be determined according to a prior knowledge about an association relationship among the plurality of measurements. Sometimes the association relationship among the measurements is known. Based on the prior knowledge about the known association relationship, the measurements may be classified into a new set as illustrated in Table 4. As illustrated in Table 4, the following three measurements PhaseUTempDif, PhaseVTempDif, and PhaseWTempDif are related to three phases of the temperature and the average, accordingly, they may be classified into a same set of measurements.

TABLE 4
Example Set of Measurements

| Measurement | |
|---|---|
| Name | Description |
| PhaseUTempDif | Difference between the maximum phase U |
| | temperature and the average from the |
| | rest of the power modules |
| PhaseVTempDif | Difference between the maximum phase V |
| | temperature and the average from the |
| | rest of the power modules |
| PhaseWTempDif | Difference between the maximum phase W |
| | temperature and the average from the |
| | rest of the power modules |

It is to be understood that the above paragraphs have described the process for classifying the measurements into a plurality of sets are only example based on measurements of a wind converter with a specific type. For another wind converter with a different type, the measurements may be different from the above example and those skilled in the art may classify these measurements into different sets according to the above classifying process.

In some embodiments of the present disclosure, the above described method for monitoring the wind converter may be implemented based on any of the sets of measurements as illustrated in Tables 2, 3, and 4. Specifically, second data of a second set of measurements (such as the set illustrated in Table 2) may be collected from respective wind converts in a group of wind converters. Then, second data distributions for the respective wind converters may be obtained based on the second data. Next, the condition of the first wind converter based on the second data distributions. With these embodiments of the present disclosure, the data related to all the measurements in the wind converter may be utilized for determining whether there is an exception in the wind converter.

In some embodiments of the present disclosure, further management may be implemented to the abnormal wind converter. For example, an output power of the abnormal wind converter may be adjusted, and/or an output power dispatch among the group of wind converters may be adjusted.

Here, the monitoring result generated based on the above description may be sent to a control center of the wind turbine to which the abnormal wind converter belongs, so as to adjust the output power accordingly. If the abnormal condition is evaluated to be very serious, the output power of the corresponding wind turbine may be set to a value lower than the original value so as to reduce the workload of the wind converter. In another example, the monitoring result may also be sent to a service center to inform the trouble-shooting engineers to schedule maintenance and repair activities. If multiple wind converters are identified as abnormal with respect to similar causes of exceptions, these wind converters may be repaired together so as to reduce the maintenance cost. In still another example, the monitoring result may be sent to the farm control center to guide power dispatch among wind turbines. Here, the abnormal wind converter may be allocated with a lower output power and the normal wind converters may be allocated with a higher output power, such that the total output power of the wind farm may remain unchanged.

The preceding paragraphs have described the method for monitoring the wind converter based on data related to one or more sets of measurements. Hereinafter, reference will be made to FIG. 8 to describe how to monitoring a group of wind converters in the wind farm. FIG. 8 illustrates a schematic flowchart of a method 800 for managing a group of wind converters in accordance with embodiments of the present disclosure. In this embodiment, the group of wind converters may include “WC1,” “WC2,” . . . , and “WC10.” At 810, a plurality of measurements may be classified into multiple sets of measurements. For example, the plurality of measurements may be classified into two sets of measurements as illustrated in Table 2 and Table 3, respectively.

At 820, one set of the measurements (such as the set illustrated in Table 2) may be selected as basis for the monitoring. At 830, the conditions of the two wind converters “WC1,” “WC2,” . . . , and “WC10” may be monitored based on the selected set of measurements. At 840, if “WC1” is identified as an abnormal wind converter, a cause may be determined according to the contribution of each measurement to the deviation. Then, the abnormal “WC1” may be removed from the group to form an updated group including “WC2,” . . . , and “WC10.” Afterwards, the process may return to the block 830 to detect another abnormal wind converter in the updated group. Although not illustrated in FIG. 8, if all the remaining wind converts in the updated group are normal, the process may go back to the block 820 to select another set of measurements as grounds for the further monitoring.

In embodiments of the present disclosure, the monitoring process may be repeated in several rounds based on different sets of measurements. Sometimes, there may be a possibility that different rounds may provide different results. For example, the monitoring based on the first set of measurements may indicate that “WC6” has some problem on IGBT in ISU cabinet, and the monitoring based on the second set of measurements may tell “WC1” is defective on IGBT in INU cabinet. Although the results appear to be inconsistent, they are actually correct because the two sets of measurements focus on different aspects of the wind converter, and thus the two wind converter “WC6” and “WC1” may have defects in ISU cabinet and INU cabinet respectively. In order to provide clear conditions of the group of wind converters, a voting process may be provided based on an OR logic to combine all the monitoring results based on all the sets of the measurements, such that all the potential abnormal wind converters may be identified.

With embodiments of the present disclosure, conditions of the wind converters in the wind farm may be monitored based on data collected in real time without a record of historical data of the wind farm. Further, based on the monitored conditions, the maintenance activity may be scheduled in advance in a more efficient manner, potential loss caused by device breakdown may be reduced, and the lifetime of whole wind farm may be balanced proactively. Although the preceding paragraphs have described details of the methods for wind converter management. The embodiments of the present disclosure may be implemented by apparatuses, systems, and computer readable medium.

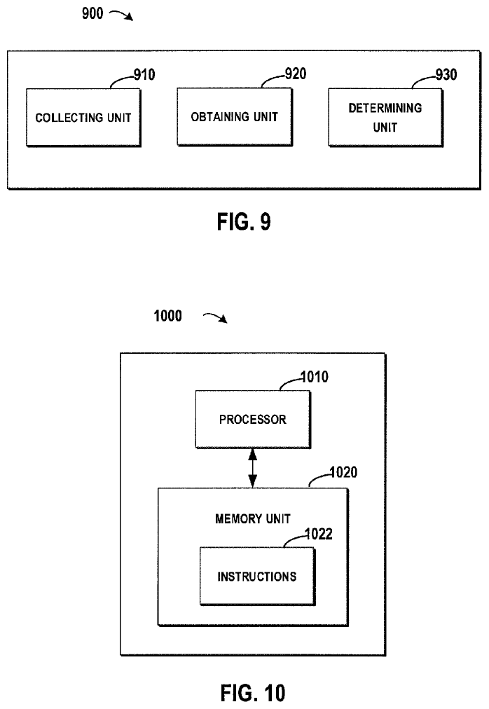

In some embodiments of the present disclosure, an apparatus for wind converter management is provided. FIG. 9 illustrates a schematic diagram of an apparatus 900 for wind converter management in accordance with embodiments of the present disclosure. As illustrated in FIG. 9, the apparatus 900 may comprises: a collecting unit 910 configured to collect data of a first set of measurements from respective wind converters in a group of wind converters; an obtaining unit 920 configured to obtain data distributions for the respective wind converters based on the collected data; and a determining unit 930 configured to determine a condition of a first wind converter in the group of wind converters based on the obtained data distributions. Here, the apparatus 900 may implement the method for wind converter management as described in the preceding paragraphs, and details will be omitted hereinafter.

In some embodiments of the present disclosure, a system for wind converter management is provided. FIG. 10 illustrates a schematic diagram of a system 1000 for wind converter management in accordance with embodiments of the present disclosure. As illustrated in FIG. 10, the system 1000 may comprise a computer processor 1010 coupled to a computer-readable memory unit 1020, and the memory unit 1020 comprises instructions 1022. When executed by the computer processor 1010, the instructions 1022 may implement the method for wind converter management as described in the preceding paragraphs, and details will be omitted hereinafter.

In some embodiments of the present disclosure, a computer readable medium for wind converter management is provided. The computer readable medium has instructions stored thereon, and the instructions, when executed on at least one processor, may cause at least one processor to perform the method for wind converter management as described in the preceding paragraphs, and details will be omitted hereinafter.

In some embodiments of the present disclosure, an Internet of Things (IoT) system for wind converter management is provided. The IoT may comprise a group of wind converter; and an apparatus for wind converter management as described in the preceding paragraphs, and details will be omitted hereinafter.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIG. 3. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for wind converter management, comprising:
collecting data of a first set of measurements from respective wind converters in a group of wind converters;
obtaining data distributions for the respective wind converters based on the collected data; and
determining a condition of a first wind converter in the group of wind converters based on the obtained data distributions.

2. The method of claim 1, wherein the determining a condition of the first wind converter comprises:
in response to a determination that the data distribution for the first wind converter deviates from data distributions for other wind converters in the group of wind converters, identifying the first wind converter as abnormal.

3. The method of claim 2, further comprising:
in response to the first wind converter being identified as abnormal,
determining, from the first set of measurements, a candidate measurement that results in a high contribution of the deviation; and
determining a cause of an exception in the first wind converter based on the candidate measurement.

4. The method of claim 2, further comprising:
in response to the first wind converter being identified as abnormal, removing the first wind converter from the group of wind converters to form an updated group of wind converters; and
determining a condition of a second wind converter in the updated group of wind converters based on the obtained data distributions.

5. The method of claim 1, wherein the determining data distributions comprises:
for at least one wind converter in the group of wind converters, determining the data distribution by a Gaussian Mixture Model.

6. The method of claim 1, wherein the determining data distributions comprises:
for at least one wind converter in the group of wind converters,
obtaining reduced-dimension data based on the data of the first set of measurements by a dimension-reducing process; and
determining the data distribution based on a data distribution of the reduced-dimension data.

7. The method of claim 1, further comprising determining the first set of measurements by classifying a plurality of measurements of the wind converters into sets according to any of:
locations at which the plurality of measurements are produced in the wind converters; and/or
a prior knowledge about an association relationship among the plurality of measurements.

8. The method of claim 7, further comprising:
collecting second data of a second set of measurements from respective wind converts in a group of wind converters;
obtaining second data distributions for the respective wind converters based on the second data; and
determining the condition of the first wind converter based on the second data distributions.

9. The method of claim 1, further comprising:
in response to data distributions for the group of wind converters being in consistent with each other, identifying the group of wind converters as normal.

10. The method of claim 2, further comprising:
in response to the first wind converter being identified as abnormal,
adjusting an output power of the first wind converter; and/or
adjusting an output power dispatch among the group of wind converters.

11. An apparatus for wind converter management, comprising:
a collecting unit configured to collect data of a first set of measurements from respective wind converters in a group of wind converters;
an obtaining unit configured to obtain data distributions for the respective wind converters based on the collected data; and
a determining unit configured to determine a condition of a first wind converter in the group of wind converters based on the obtained data distributions.

12. The apparatus of claim 11, wherein the determining unit comprises:
an identifying unit configured to, in response to a determination that the data distribution for the first wind converter deviates from data distributions for other wind converters in the group of wind converters, identify the first wind converter as abnormal.

13. The apparatus of claim 12, further comprising:
a measurement determining unit configured to, in response to the first wind converter being identified as abnormal, determine, from the first set of measurements, a candidate measurement that results in a high contribution of the deviation; and
a cause determining unit configured to determine a cause of an exception in the first wind converter based on the candidate measurement.

14. The apparatus of claim 12, further comprising:
a removing unit configured to, in response to the first wind converter being identified as abnormal, remove the first wind converter from the group of wind converters to form an updated group of wind converters; and
wherein the condition determining unit is configured to determine a condition of a second wind converter in the updated group of wind converters based on the obtained data distributions.

15. The apparatus of claim 11, wherein the determining unit comprises:
a distribution determining unit configured to for at least one wind converter in the group of wind converters, determine the data distribution by a Gaussian Mixture Model.

16. The apparatus of claim 11, wherein the determining unit comprises a distribution determining unit configured to:
for at least one wind converter in the group of wind converters,
obtain reduced-dimension data based on the data of the first set of measurements by a dimension-reducing process; and
determine the data distribution based on a data distribution on the reduced-dimension data.

17. The apparatus of claim 11, further comprising a classifying unit configured to classify a plurality of measurements of the wind converters into sets according to any of
locations at which the plurality of measurements are produced in the wind converters; and/or
a prior knowledge about an association relationship among the plurality of measurements.

18. The apparatus of claim 17, wherein:
the collecting unit is further configured to collect second data of a second set of measurements from respective wind converts in a group of wind converters;
the obtaining unit is further configured to obtain second data distributions for the respective wind converters based on the collected second data; and
the determining unit is further configured to determine the condition of the first wind converter based on the second data distributions.

19. The apparatus of claim 11, wherein the determining unit comprises:
an identifying unit configured to in response to data distributions for the group of wind converters being in consistent with each other, identify the group of wind converters as normal.

20. The apparatus of claim 12, further comprising an adjusting unit configured to, in response to the first wind converter being identified as abnormal,
adjust an output power of the first wind converter; and/or
adjust an output power dispatch among the group of wind converters.

21. A system for wind converter management, comprising:
a computer processor coupled to a computer-readable memory unit, the memory unit comprising instructions that when executed by the computer processor:
collect data of a first set of measurements from respective wind converters in a group of wind converters;
obtain data distributions for the respective wind converters based on the collected data; and
determine a condition of a first wind converter in the group of wind converters based on the obtained data distributions.

22. A non-transitory computer readable medium having instructions stored thereon, the instructions, when executed on at least one processor, cause the at least one processor to:
collect data of a first set of measurements from respective wind converters in a group of wind converters;
obtain data distributions for the respective wind converters based on the collected data; and
determine a condition of a first wind converter in the group of wind converters based on the obtained data distributions.

23. (canceled)
